(19) United States
(12) Patent Application Publication
(10) Pub. No.: US 2025/0337281 A1
(43) Pub. Date: Oct. 30, 2025

(54) AMBIENT POWER DEVICE CHARGING SYSTEM IN CELLULAR NETWORKS

(71) Applicant: Cisco Technology, Inc., San Jose, CA (US)

(72) Inventors: Indermeet Singh Gandhi, San Jose, CA (US); Jerome Henry, Pittsboro, NC (US); Robert Edgar Barton, Richmond (CA)

(21) Appl. No.: 18/644,629

(22) Filed: Apr. 24, 2024

(51) Int. Cl. H02J 50/20; H02J 7/00; H02J 50/40; H02J 50/80

(52) U.S. Cl. CPC H02J 50/20; H02J 7/00034; H02J 50/40; H02J 50/80

(57) ABSTRACT

Dynamic wireless charging coordination and management tailored to scale and constraints of AMP backscatter IoT devices are provided. The method involves obtaining, by a radio access network controller, an energy requirement for one or more ambient Internet of Things (IoT) devices and generating a charging schedule for the one or more ambient IoT devices including a charging window and energy beamforming parameters for charging a respective IoT device based on the energy requirement. The method further involves providing the charging schedule for charging the one or more ambient IoT devices.

### TECHNICAL FIELD

The present disclosure generally relates to wireless communication.

### BACKGROUND

The number of ambient power (AMP) Internet of Things (IoT) devices is growing rapidly. These AMP IoT devices include, among other things, sensors, tags, and wearables, which may be powered by ambient power such as radio waves, solar energy, heat, vibrations, and other energy sources in their environment. Remote wireless charging allows these devices to operate without batteries or with minimal stored energy. For example, an AMP IoT device may collect energy from radio frequency signals in cellular network(s). Without adequate energy, these devices cannot perform their intended function(s) such as sensing, monitoring, controlling, and/or reporting functions. The proliferation of these AMP IoT devices that rely on energy harvesting presents a challenge for cellular networks such as future 5th generation (5G) network(s).

### BRIEF DESCRIPTION OF THE DRAWINGS

FIG. 1 is a block diagram illustrating an environment in which targeted wireless charging of one or more ambient IoT devices is performed according to a charging schedule generated at a radio access network intelligent controller, according to an example embodiment.

FIG. 2 is a sequence diagram illustrating a method of performing targeted wireless charging of one or more ambient IoT devices based on a generated charging schedule, according to an example embodiment.

FIG. 3 is a flowchart illustrating a method of generating and providing a charging schedule for charging one or more ambient IoT devices, according to an example embodiment.

FIG. 4 is a hardware block diagram of a computing device that may perform functions associated with any combination of operations in connection with the techniques depicted and described in FIGS. 1-3, according to various example embodiments.

### DETAILED DESCRIPTION

### Overview

Techniques presented herein provide for dynamic wireless charging coordination and management tailored to scale and constraints of AMP backscatter IoT devices.

In one form, the method involves obtaining, by a radio access network controller, an energy requirement for one or more ambient Internet of Things (IoT) devices and generating a charging schedule for the one or more ambient IoT devices including a charging window and energy beamforming parameters for charging a respective IoT device based on the energy requirement. The method further involves providing the charging schedule for charging the one or more ambient IoT devices.

### Example Embodiments

As noted above, with the proliferation of battery-operated wireless devices, particularly in IoT environments, being able to remotely charge these devices over a wireless technology would be beneficial. Existing fourth generation (4G) long-term evolution (LTE) and emerging 5G cellular networks lack efficient mechanisms to dynamically manage energy harvesting and charging needs of massive numbers of AMP IoT devices simultaneously connected to the network. A dynamic wireless charging coordination and management system and method, tailored to the scale and constraints of AMP backscatter IoT devices, is desirable.

Typically, IoT devices are devices that transmit data over one or more networks and perform a specific function such as monitoring, sensing, reporting, and/or processing. IoT devices are widely used in industries such as consumer electronics, smart cities, healthcare, automotive, etc. AMP IoT devices are a new class of IoT devices that harvest energy from viable ambient source(s) e.g., air power charging. For example, an AMP IoT device may operate without a dedicate power source (e.g., a battery) and may harvest energy from an electromagnetic source. AMP IoT devices may have capacity for energy storage but typically are low in complexity and power consumption.

An AMP IoT device may be power charged via a core 5G network. For example, the AMP IoT device may register with the core 5G network and send a charging request to the core 5G network. The core 5G network may then instruct a wireless base station (e.g., 5G gNodeB) to charge the AMP IoT device using millimeter wave charging. In this technique, the core 5G network serves as an orchestrator for an energy harvesting process for the AMP IoT device. However, with the number of AMP IoT devices growing exponentially, it may be cumbersome and time consuming to orchestrate an energy harvesting process through the core 5G network.

Techniques presented herein provide for dynamic wireless charging coordination and management tailored to the scale and constraints of AMP backscatter IoT devices. In the these techniques, an open radio access network (O-RAN) may coordinate and manage charging for AMP IoT devices. The AMP IoT devices may communicate charging or energy requirements to a cellular radio access network (RAN) over radio resource control (RRC) signaling, as opposed to involving the core 5G network. The techniques presented herein provide an ambient charging and coordination function (ACCF) installed at a RAN intelligent controller (RIC) e.g., in a form of an application. The ACCF analyzes charging or energy requirements and generates a charging schedule to the cellular RAN network over an E2 Application Protocol (E2AP).

The techniques presented herein provide a method for obtaining an energy requirement for one or more ambient Internet of Things (IoT) devices and generating a charging schedule for the one or more ambient IoT devices including a charging window and energy beamforming parameters for charging a respective IoT device based on the energy requirement. The method further involves providing the charging schedule for charging the one or more ambient IoT devices.

While one or more example embodiments are described with reference to an open radio access system/network, one of ordinary skill in the art would readily appreciate that example embodiments may be applicable to other access systems/networks now known or hereinafter developed.

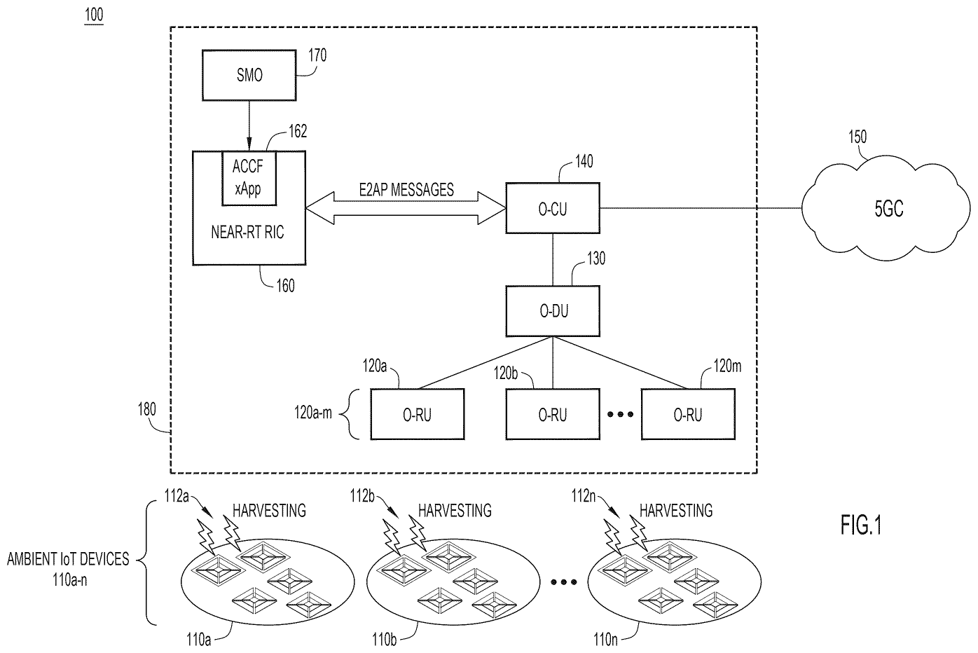

FIG. 1 is a block diagram illustrating an environment 100 in which targeted wireless charging of one or more ambient IoT devices is performed according to a generated charging schedule at a radio access network intelligent controller, according to an example embodiment. The environment 100 includes ambient IoT devices 110a-n, a 5G core network (5GC network 150), and an open radio access network (O-RAN) 180.

The notations 1, 2, 3, . . . n; a, b, c, . . . n; “a-n”, “a-m”, “a-f”, “a-g”, “a-k”, “a-c”, and the like illustrate that the number of elements can vary depending on a particular implementation and is not limited to the number of elements being depicted or described. Moreover, this is only examples of various components, and the number and types of components, functions, etc. may vary based on a particular deployment and use case scenario.

As noted above, an IoT device may be any device that collects and exchanges data over network(s). An ambient IoT device may be any device in the IoT environment that harvests ambient power. The ambient IoT devices 110a-n are typically compact in size (small form factor) and low in complexity and power consumption. Not all ambient IoT devices 110a-n are battery powered. Some IoT technologies involve ambient IoT devices 110a-n with no energy storage capability e.g., wireless sensors, or devices with energy storage that do not need to be replaced or recharged manually.

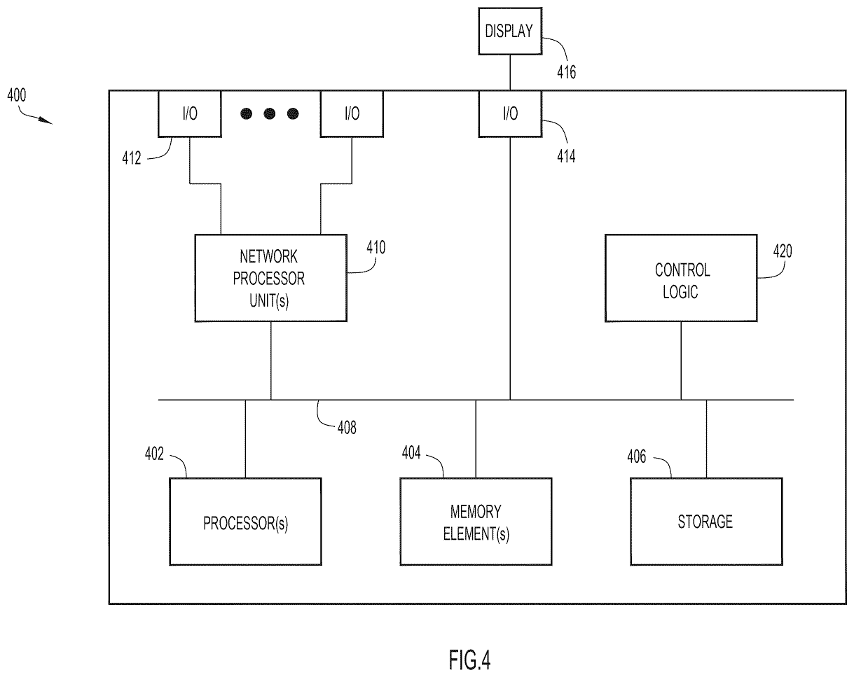

Each of the ambient IoT devices 110a-n may include a processor, a sensor, and/or a memory in addition to a network interface and an AMP harvesting system. An IoT device may be an apparatus or any programmable electronic or computing device capable of executing computer readable program instructions. The ambient IoT devices 110a-n may include internal and external hardware components such as those depicted and described in further detail in FIG. 4.

The network interface may include one or more network interface cards (having one or more ports) that enable components of the IoT device to send and receive packets or data over network(s) such as a local area network (LAN) or a wide area network (WAN), and/or wireless access networks. The network interface may connect the IoT device to a radio access network (RAN) for data communication over a core network e.g., cellular network such as 5G core network, 4G LTE, etc.

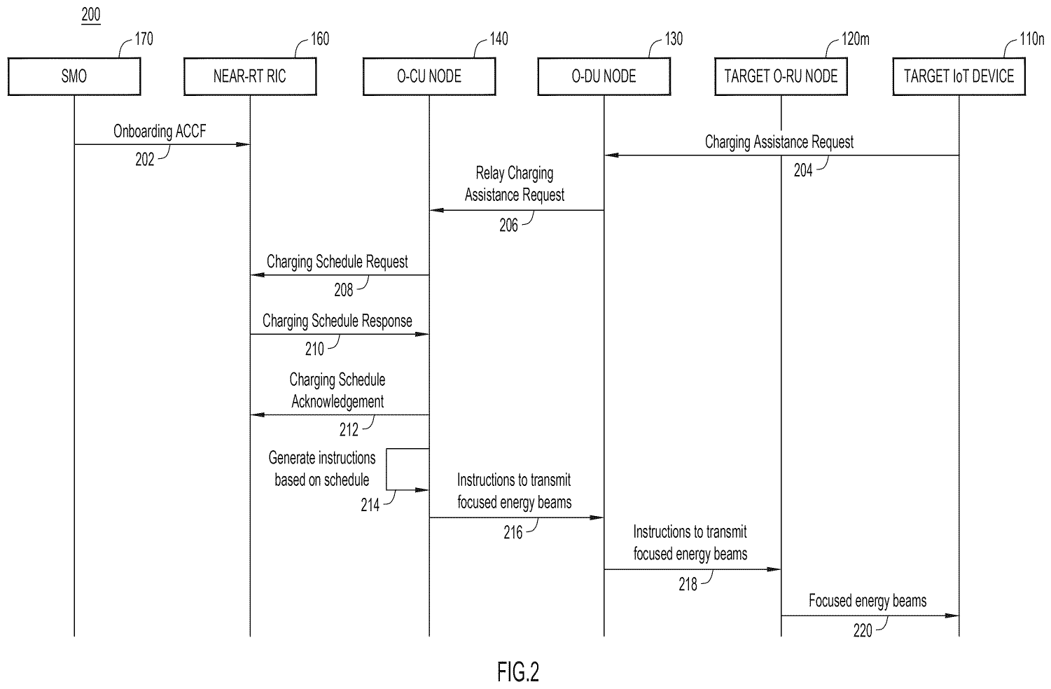

The AMP harvesting system includes a radio frequency (RF) energy receiving antenna and a rectifier that converts RF signals into energy for use by a respective IoT device. For example, the IoT devices 110a-n include a first IoT device 110a having a first AMP harvesting system 112a, a second IoT device 110b having a second AMP harvesting system 112b, and a third IoT device i.e., a target IoT device 110n that is to be charged as detailed in FIG. 2 and that has a third AMP harvesting system 112n.

The ambient IoT devices 110a-n are configured to periodically monitor respective capacitor energy levels. When a capacitor energy level depletes below a predetermined threshold value for an ambient IoT device, the ambient IoT device generates a charging assistance request Radio Resource Control (RRC) message with a device identifier, a current energy level, location coordinates, etc. This RRC message is then transmitted over a Uu interface on a dedicated network slice for the ambient IoT device to the 5G RAN (O-RAN). For example, when the target IoT device 110n determines that its capacitor energy level is below 20% (depleted below a predetermined threshold of 20%), a charging assistance request message is generated. The charging assistance request message includes a unique identifier (UID) such as a media access control (MAC) address of the target IoT device 110n, energy level of the target IoT device 110n (e.g., 19%), and a location such as Global Positioning System (GPS) coordinates. The charging assistance request message is transmitted to the O-RAN.

The environment 100 may include a split 5G RAN architecture defined by O-RAN alliance. The split 5G RAN network includes the 5GC network 150 defined by the third generation Partnership Project (3GPP) standard. The 5GC network 150 is not involved in scheduling and providing the charging schedule. The split 5G RAN network includes the O-RAN 180 that generates the charging schedule for charging the ambient IoT devices 110a-n. The O-RAN 180 is ambient power charging enabled. That is, the O-RAN 180 generates and transmits energy beams or radio frequency energy signals for charging the ambient IoT devices 110a-n.

The O-RAN 180 includes open radio unit nodes (O-RU nodes) 120a-m, an open distributed unit node (O-DU node) 130, an open central unit node (O-CU node) 140, a near real-time RAN intelligent controller (Near-RT RIC) 160, and a service management orchestrator (SMO) 170.

The O-RU nodes 120a-m are logical nodes that host low-PHY layer and RF processing. In addition to facilitating communication for the ambient IoT devices 110a-n, the O-RU nodes 120a-m are energy beamforming charging resources configured to charge the ambient IoT devices 110a-n. For example, an O-RU node may be a 5G gNodeB of the O-RAN 180 that generates and transmits RF energy signals (energy beams) towards an ambient IoT device for charging e.g., in the form of millimeter wave (mmWave) charging frames. The O-RU nodes 120a-m may provide continuous energy or power charging while also streaming data. The O-RU nodes 120a-m communicate with and charge the ambient IoT devices 110a-n by transmitting RF signals via a near air interface e.g., NR-Uu interface. The O-RU nodes 120a-m include a first O-RU node 120a, a second O-RU node 120b, and a third O-RU node i.e., a target O-RU node 120m that is selected for charging the target IoT device 110n detailed in FIG. 2.

The O-DU node 130 is a logical node that hosts another set of protocols and functions which include the radio link control (RLC) protocol, the medium access control (MAC) protocol, and the physical layer (PHY) interface. The O-DU node 130 uses the O-RU nodes 120a-m for wireless charging of the ambient IoT devices 110a-n. Specifically, the O-DU node 130 transmits focused energy beams over dedicated airtime resources i.e., the O-RU nodes 120a-m, toward one or more of the ambient device antennas 112a-n to enable targeted wireless charging, as instructed by the O-CU node 140. As an example, the O-DU node 130 may charge the target IoT device 110n using the target O-RU node 120m. The O-DU node 130 also relays messages between the O-CU node 140 and the ambient IoT devices 110a-n, via the O-RU nodes 120a-m. The O-DU node 130 uses an open fronthaul interface e.g., F1 interface, to communicate with the O-CU node 140.

The O-CU node 140 is a logical node that hosts the Radio Resource Control (RRC) protocol, Service Data Adaptation Protocol (SDAP), and Packet Data Convergence Protocol (PDCP). The O-CU node 140 encapsulates charging assistance details received from the charging assistance request RRC message into a newly defined E2 Application Protocol (E2AP) message. The E2AP message includes the device identifier, the energy level, and the location coordinates. In one example embodiment, the E2AP message may include an aggregation of charging assistance request RRC messages. The E2AP message is transmitted over E2 interface to the Near-RT RIC 160.

The O-CU node 140 further receives a charging schedule from the Near-RT RIC 160. The charging schedule includes a device identifier, a charging window, energy beamforming parameters, and allocated air interface resources. For example, the charging schedule may include: (1) identity of the target IoT device 110n (e.g., MAC address), (2) one or more time slots (e.g., charge at 12:00:00 to 12:03:50 and at 12:05:00 to 12:08:50), (3) energy beamforming parameters such as steering angle and/or weighing factors (wm), (4) allocated available energy beamforming charging resources such as an identity of the target O-RU node 120m. The O-CU node 140 also acknowledges receipt of the charging schedule and directs the O-DU node 130 to transmit focused energy beams over dedicated airtime resources e.g., the first O-RU node 120a and the target O-RU node 120m towards an ambient IoT device antenna e.g., the third AMP harvesting system 112n, to perform targeted wireless charging.

The Near-RT RIC 160 is a logical function that enables near real-time control and optimization of O-RAN elements and resources. The Near-RT RIC 160 controls and optimizes elements and resources with granular data collection and communication over the E2 interface. The E2 interface connects the Near-RT RIC 160 with the O-CU node 140 and/or the O-DU node 130. The Near-RT RIC 160 includes an AMP Charging Coordination Function (ACCF) xApp i.e., an ACCF 162.

The ACCF 162 leverages open interfaces of the O-RAN 180 to dynamically schedule and manage wireless charging of the ambient IoT devices 110a-n connected to the 5GC network 150. The ACCF 162 may be defined as a new xApp hosted on a platform of the Near-RT RIC 160. The ACCF 162 is designed to coordinate charging operations for the ambient IoT devices 110a-n. The ACCF 162 maintains a datastore (a database) for tracking parameters of the ambient IoT devices 110a-n. The tracking parameters may include battery (capacitor) levels, charging efficiency curves (charging curve related data), location coordinates, mobility patterns, beamforming characteristics, and harvesting antenna parameters. Based on receiving one or more messages (e.g., energy information of the ambient IoT devices 110a-n or charging requests), the ACCF 162 runs algorithms leveraging tracking parameters in the datastore to compute an efficient charging schedule coordinating all active charging requests. Scheduled window(s) are conveyed to the O-CU node 140 using the newly defined E2AP message. In one example embodiment, the charging schedule includes a charging window(s) for each respective IoT device and energy beamforming parameters including allocated beamforming resources.

The SMO 170 provides automation for the O-RAN 180. The SMO 170 may be used to develop applications for the O-RAN 180. The SMO 170 may further include non-real-time RIC. The SMO 170 is configured to onboard policies and application onto the Near-RT RIC 160. Specifically, the SMO 170 onboards the ACCF 162 as an xApp onto the Near-RT RIC 160. The ACCF 162 may be developed to include predetermined thresholds, optimization algorithms, and other rules for generating the charging schedule.

With continued reference to FIG. 1, FIG. 2 is a sequence diagram illustrating a method 200 of performing targeted wireless charging of one or more ambient IoT devices based on a generated charging schedule, according to an example embodiment.

The method 200 involves the target IoT device 110n (i.e., one of the ambient IoT devices 110a-n of FIG. 1) and the target O-RU node 120m (i.e., one of the O-RU nodes 120a-m of FIG. 1). One of ordinary skill in the art would readily appreciate that this is just an example and multiple O-RU nodes may be used as energy beamforming charging resources. Additionally, while the method 200 involves charging only the target IoT device 110n, the generated schedule may include multiple ambient IoT devices to be charged. The method 200 further involves the O-DU node 130, the O-CU node 140, the Near-RT RIC 160, and the SMO 170 of FIG. 1. These are just non-limiting examples of radio access network entities and the disclosure is not limited thereto.

In the method 200, at 202, the SMO 170 provides the ACCF 162 to the Near-RT RIC 160. The ACCF 162 is then hosted on the Near-RT RIC 160 as a new xApp. The ACCF 162 coordinates charging operations for the ambient IoT devices 110a-n of FIG. 1. Specifically, the ACCF 162 maintains a datastore for target devices tracking parameters such as battery (capacitor) levels, charging efficiency curves and curve related data, location coordinates, mobility patterns, beamforming characteristics and harvesting antenna parameters. The ACCF 162 is configured to generate a coordinated charging schedule based on energy requirements of the ambient IoT devices 110a-n of FIG. 1. That is, ambient IoT devices periodically monitor and report their capacitor energy levels to O-CU node 140 via a respective O-RU node and the O-DU node 130.

In the method 200, at 204, the target IoT device 110n generates and transmits a charging assistance request to the O-CU node 140 via the target O-RU node 120m and the O-DU node 130. In one example embodiment, the charging assistance request (e.g., energy requirement) may be generated when the capacitor energy level depletes below a predetermined threshold. In yet another example embodiment, each IoT device may periodically report its capacitor energy level to the O-CU node 140 (e.g., provide energy requirement), which then determines whether charging is to be performed based on communications with the Near-RT RIC 160 and/or the charging schedule already generated and stored at the O-CU node 140. The energy requirement (the charging assistance request) may be an RRC message that includes device-ID (UID), energy level (that may be depleted below a predetermined threshold), location coordinates etc. This message is transmitted over the Uu interface on a dedicated network slice for the target IoT device 110n to the O-DU node 130 via the target O-RU node 120m.

Based on receiving the message (i.e., the energy requirement), at 206, the O-DU node 130 relays the charging assistance information in the message towards the O-CU node 140 over the F1 interface.

The O-CU node 140 encapsulates the charging assistance details (energy requirement) in a newly defined E2AP message charging schedule request and at 208, transmits the E2AP message charging schedule request over the E2 interface to the Near-RT RIC 160 (i.e., the ACCF 162).

Based on receiving the E2AP message charging schedule request, the ACCF 162 runs algorithms leveraging its device datastore (tracking parameters) to compute an efficient charging schedule coordinating all active charging requests and available energy beamforming charging resources. The ACCF 162 obtains, from a datastore, tracking parameters of the target IoT device 110n including charging curve related data, location coordinates, a mobility pattern, energy beamforming characteristics, and/or harvesting antenna parameters and computes the charging schedule based on these tracking parameters.

For example, the ACCF 162 is configured to determine whether a capacitor energy level of the target IoT device 110n is depleted below a minimum predetermined threshold (e.g., 5%) such that charging is to be urgently performed (prioritize charging and energy beamforming charging resources), or is depleted below another predetermined threshold (e.g., 30%) such that charging is to be performed when there is an available time slot and an available energy beamforming charging resource. The optimization algorithm may also consider tracking parameters such as charging curve related data, mobility pattern, energy beamforming characteristics, and/or harvesting antenna parameters in generated the charging schedule. For example, some IoT devices may use a longer time slot or charging window than others to achieve the same amount of charging (some may charge slower than others depending on the charging curve related data). As another example, an IoT device may be stationary (mobility pattern at zero) and as such, it is easier to charge (focus energy beams) than a (high mobility pattern) IoT device that is moving (e.g., installed in a moving vehicle).

The charging schedule coordinates charging among the ambient IoT devices and available energy beamforming charging resources. The charging schedule may include a device identifier of the target IoT device 110n, charging time slots (charge from 13:00 to 13:10 as a first charging time slot and charge from 14:00 to 14:10 as a second charging time slot), energy beamforming details, and an allocated air interface charging resource (i.e., the target O-RU node 120m).

At 210, the charging schedule is conveyed to the O-CU node 140 using another newly defined E2AP message charging schedule response in which the device ID, time slots, beamforming details, and allocated air interface resources are identified.

At 212, the O-CU node 140 confirms receipt of the charging schedule using an E2AP charging schedule acknowledgment message over the E2 interface.

The O-CU node 140 processes or analyzes the charging schedule and generates instructions for the O-DU node 130 to charge various devices based on the schedule. Specifically, at 214, the O-CU node 140 generates instructions to charge target IoT device 110n based on the charging schedule and at 216, the instructions are transmitted to the O-DU node 130. That is, based on the charging schedule, the O-CU node 140 directs the O-DU node 130 to transmit focused energy beams over dedicated airtime resources (i.e., the target O-RU node 120m) towards the ambient device antenna to enable targeted wireless charging. At 218, the O-DU node 130 instructs the target O-RU node 120m to transmit focused energy beams and at 220, the target O-RU node 120m focuses energy beams onto the target IoT device 110n, as instructed by the O-DU node 130.

As such, the techniques presented herein involve an ambient charging coordination function that generates a charging schedule in an O-RAN for charging one or more ambient IoT devices. While the method 200 involves only one IoT device, the disclosure provides for coordinated charging of multiple ambient IoT devices based on the tracking parameters. The Near-RT RIC 160 is configured to leverage open interfaces of O-RAN to dynamically manage wireless charging of ambient IoT devices connected to the core 5G network via the O-RAN.

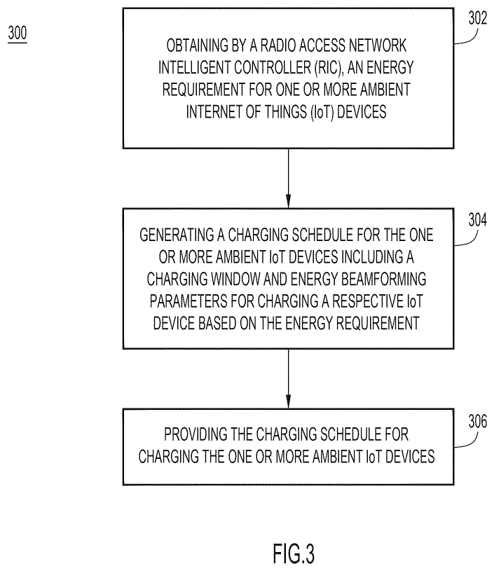

FIG. 3 is a flowchart illustrating a computer-implemented method 300 of generating and providing a charging schedule for charging the one or more ambient IoT devices, according to an example embodiment. The computer-implemented method 300 may be performed by one or more computing devices or an apparatus. For example, the computer-implemented method 300 may be performed by a radio access network intelligent controller (RIC) such as the Near-RT RIC 160 of FIG. 1 or FIG. 2.

The computer-implemented method 300 involves at 302, obtaining an energy requirement for one or more ambient Internet of Things (IoT) devices.

The computer-implemented method 300 further involves at 304, generating a charging schedule for the one or more ambient IoT devices including a charging window and energy beamforming parameters for charging a respective IoT device based on the energy requirement.

The computer-implemented method 300 further involves at 306, providing the charging schedule for charging the one or more ambient IoT devices.

In one instance, the operation 306 of providing the charging schedule may include providing, to an open central unit node of a radio access network, the charging schedule for charging, by one or more open radio unit nodes of the radio access network, the one or more ambient IoT devices based on the charging schedule.

According to one or more example embodiments, the one or more ambient IoT devices may include a plurality of ambient IoT devices. The computer-implemented method 300 may further include obtaining available energy beamforming charging resources. The charging schedule may coordinate charging among the plurality of ambient IoT devices further based on the available energy beamforming charging resources.

According to one or more example embodiments, the energy requirement may be included in a charging assistance request message. The charging assistance request message may further include a device identifier, an energy level, and location coordinates. The charging assistance request message may be generated by the respective IoT device.

In one form, the charging assistance request message may be generated based on a capacitor energy level of the respective IoT device depleting below a predetermined threshold.

In another form, the charging schedule may include a device identifier, one or more charging time slots, energy beamforming details, and one or more allocated air interface charging resources, for charging the respective IoT device.

According to one or more example embodiments, the energy requirement may include information about a charging level of a first ambient IoT device and a second ambient IoT device.

According to one or more example embodiments, the operation 304 of generating the charging schedule for the one or more ambient IoT devices may include obtaining, from a datastore, tracking parameters of the first ambient IoT device and the second ambient IoT device including one or more of: charging curve related data, location coordinates, a mobility pattern, energy beamforming characteristics, or harvesting antenna parameters. The operation 304 may further include computing the charging schedule further based on the tracking parameters. The charging schedule may include a first charging window for the first ambient IoT device and a second charging window for the second ambient IoT device in which the respective IoT device is charged by one or more open radio unit nodes of a radio access network.

In one instance, the charging schedule may be provided in an E2 application protocol message.

FIG. 4 is a hardware block diagram of a computing device 400 that may perform functions associated with any combination of operations in connection with the techniques depicted in FIGS. 1-3, according to various example embodiments, including, but not limited to, operations of one or more entities of FIGS. 1 and 2 such as one of the ambient IoT devices 110a-n, one of the O-RU nodes 120a-m, the O-DU node 130, the O-CU node 140, the Near-RT RIC 160, or the SMO 170. It should be appreciated that FIG. 4 provides only an illustration of one example embodiment and does not imply any limitations with regard to the environments in which different example embodiments may be implemented. Many modifications to the depicted environment may be made.

In at least one embodiment, computing device 400 may include one or more processor(s) 402, one or more memory element(s) 404, storage 406, a bus 408, one or more network processor unit(s) 410 interconnected with one or more network input/output (I/O) interface(s) 412, one or more I/O interface(s) 414, and control logic 420. In various embodiments, instructions associated with logic for computing device 400 can overlap in any manner and are not limited to the specific allocation of instructions and/or operations described herein.

In at least one embodiment, processor(s) 402 is/are at least one hardware processor configured to execute various tasks, operations and/or functions for computing device 400 as described herein according to software and/or instructions configured for computing device 400. Processor(s) 402 (e.g., a hardware processor) can execute any type of instructions associated with data to achieve the operations detailed herein. In one example, processor(s) 402 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, one or more memory element(s) 404 and/or storage 406 is/are configured to store data, information, software, and/or instructions associated with computing device 400, and/or logic configured for memory element(s) 404 and/or storage 406. For example, any logic described herein (e.g., control logic 420) can, in various embodiments, be stored for computing device 400 using any combination of memory element(s) 404 and/or storage 406. Note that in some embodiments, storage 406 can be consolidated with one or more memory elements 404 (or vice versa), or can overlap/exist in any other suitable manner.

In at least one embodiment, bus 408 can be configured as an interface that enables one or more elements of computing device 400 to communicate in order to exchange information and/or data. Bus 408 can be implemented with any architecture designed for passing control, data and/or information between processors, memory elements/storage, peripheral devices, and/or any other hardware and/or software components that may be configured for computing device 400. In at least one embodiment, bus 408 may be implemented as a fast kernel-hosted interconnect, potentially using shared memory between processes (e.g., logic), which can enable efficient communication paths between the processes.

In various embodiments, network processor unit(s) 410 may enable communication between computing device 400 and other systems, entities, etc., via network I/O interface(s) 412 to facilitate operations discussed for various embodiments described herein. In various embodiments, network processor unit(s) 410 can be configured as a combination of hardware and/or software, such as one or more Ethernet driver(s) and/or controller(s) or interface cards, Fibre Channel (e.g., optical) driver(s) and/or controller(s), and/or other similar network interface driver(s) and/or controller(s) now known or hereafter developed to enable communications between computing device 400 and other systems, entities, etc. to facilitate operations for various embodiments described herein. In various embodiments, network I/O interface(s) 412 can be configured as one or more Ethernet port(s), Fibre Channel ports, and/or any other I/O port(s) now known or hereafter developed. Thus, the network processor unit(s) 410 and/or network I/O interface(s) 412 may include suitable interfaces for receiving, transmitting, and/or otherwise communicating data and/or information in a network environment.

I/O interface(s) 414 allow for input and output of data and/or information with other entities that may be connected to computing device 400. For example, I/O interface(s) 414 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor 416, a display screen (touch screen on a mobile device), or the like.

In various embodiments, control logic 420 can include instructions that, when executed, cause processor(s) 402 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

In another example embodiment, an apparatus is provided. The apparatus includes a memory and a network interface configured to enable network communications. The apparatus further includes a processor. In this apparatus, the processor is configured to perform a method, which includes obtaining an energy requirement for one or more ambient Internet of Things (IoT) devices and generating a charging schedule for the one or more ambient IoT devices including a charging window and energy beamforming parameters for charging a respective IoT device based on the energy requirement. The method further includes providing the charging schedule for charging the one or more ambient IoT devices.

In yet another example embodiment, one or more non-transitory computer readable storage media encoded with instructions are provided. When the media is executed by a processor, the instructions cause the processor to execute a method that involves obtaining an energy requirement for one or more ambient Internet of Things (IoT) devices and generating a charging schedule for the one or more ambient IoT devices including a charging window and energy beamforming parameters for charging a respective IoT device based on the energy requirement. The method further involves providing the charging schedule for charging the one or more ambient IoT devices.

In yet another example embodiment, a system is provided that includes the devices and operations explained above with reference to FIGS. 1-4.

The programs described herein (e.g., control logic 420) may be identified based upon the application(s) for which they are implemented in a specific embodiment. However, it should be appreciated that any particular program nomenclature herein is used merely for convenience, and thus the embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, the storage 406 and/or memory elements(s) 404 can store data, software, code, instructions (e.g., processor instructions), logic, parameters, combinations thereof, and/or the like used for operations described herein. This includes the storage 406 and/or memory elements(s) 404 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., WiFi®/WiFi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein, the terms may be used in a generic sense to include packets, frames, segments, datagrams, and/or any other generic units that may be used to transmit communications in a network environment. Generally, the terms reference to a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
obtaining, by a radio access network controller, an energy requirement for one or more ambient Internet of Things (IoT) devices;
generating a charging schedule for the one or more ambient IoT devices including a charging window and energy beamforming parameters for charging a respective IoT device based on the energy requirement; and
providing the charging schedule for charging the one or more ambient IoT devices.

2. The computer-implemented method of claim 1, wherein providing the charging schedule includes:
providing, to an open central unit node of a radio access network, the charging schedule for charging, by one or more open radio unit nodes of the radio access network, the one or more ambient IoT devices based on the charging schedule.

3. The computer-implemented method of claim 1, wherein the one or more ambient IoT devices includes a plurality of ambient IoT devices and further comprising:
obtaining available energy beamforming charging resources, wherein the charging schedule coordinates charging among the plurality of ambient IoT devices further based on the available energy beamforming charging resources.

4. The computer-implemented method of claim 1, wherein the energy requirement is included in a charging assistance request message that further includes a device identifier, an energy level, and location coordinates and that is generated by the respective IoT device.

5. The computer-implemented method of claim 4, wherein the charging assistance request message is generated based on a capacitor energy level of the respective IoT device depleting below a predetermined threshold.

6. The computer-implemented method of claim 1, wherein the charging schedule includes a device identifier, one or more charging time slots, energy beamforming details, and one or more allocated air interface charging resources, for charging the respective IoT device.

7. The computer-implemented method of claim 1, wherein the energy requirement includes information about a charging level of a first ambient IoT device and a second ambient IoT device.

8. The computer-implemented method of claim 7, wherein generating the charging schedule for the one or more ambient IoT devices includes:
obtaining, from a datastore, tracking parameters of the first ambient IoT device and the second ambient IoT device including one or more of: charging curve related data, location coordinates, a mobility pattern, energy beamforming characteristics, or harvesting antenna parameters; and
computing the charging schedule further based on the tracking parameters, wherein the charging schedule includes a first charging window for the first ambient IoT device and a second charging window for the second ambient IoT device in which the respective IoT device is charged by one or more open radio unit nodes of a radio access network.

9. The computer-implemented method of claim 8, wherein the charging schedule is provided in an E2 application protocol message.

10. An apparatus comprising:
a memory;
a network interface configured to enable network communications; and
a processor, wherein the processor is configured to perform a method comprising:
obtaining an energy requirement for one or more ambient Internet of Things (IoT) devices;
generating a charging schedule for the one or more ambient IoT devices including a charging window and energy beamforming parameters for charging a respective IoT device based on the energy requirement; and
providing the charging schedule for charging the one or more ambient IoT devices.

11. The apparatus of claim 10, wherein the apparatus is a near real-time radio access network intelligent controller in a split fifth generation (5G) radio access network.

12. The apparatus of claim 10, wherein the processor is configured to providing the charging schedule by:
providing, to an open central unit node of a radio access network, the charging schedule for charging, by one or more open radio unit nodes of the radio access network, the one or more ambient IoT devices based on the charging schedule.

13. The apparatus of claim 10, wherein the one or more ambient IoT devices includes a plurality of ambient IoT devices and the processor is further configured to perform:
obtaining available energy beamforming charging resources, wherein the charging schedule coordinates charging among the plurality of ambient IoT devices further based on the available energy beamforming charging resources.

14. The apparatus of claim 10, wherein the energy requirement is included in a charging assistance request message that further includes a device identifier, an energy level, and location coordinates and is generated by the respective IoT device.

15. The apparatus of claim 14, wherein the charging assistance request message is generated based on a capacitor energy level of the respective IoT device depleting below a predetermined threshold.

16. The apparatus of claim 10, wherein the charging schedule includes a device identifier, one or more charging time slots, energy beamforming details, and one or more allocated air interface charging resources, for charging the respective IoT device.

17. One or more non-transitory computer readable storage media encoded with software comprising computer executable instructions that, when executed by a processor, cause the processor to perform a method including:
obtaining an energy requirement for one or more ambient Internet of Things (IoT) devices;
generating a charging schedule for the one or more ambient IoT devices including a charging window and energy beamforming parameters for charging a respective IoT device based on the energy requirement; and
providing the charging schedule for charging the one or more ambient IoT devices.

18. The one or more non-transitory computer readable storage media according to claim 17, wherein the computer executable instructions cause the processor to provide the charging schedule by:
providing, to an open central unit node of a radio access network, the charging schedule for charging, by one or more open radio unit nodes of the radio access network, the one or more ambient IoT devices based on the charging schedule.

19. The one or more non-transitory computer readable storage media according to claim 18, wherein the one or more ambient IoT devices includes a plurality of ambient IoT devices and wherein the computer executable instructions further cause the processor to perform:
obtaining available energy beamforming charging resources, wherein the charging schedule coordinates charging among the plurality of ambient IoT devices further based on the available energy beamforming charging resources.

20. The one or more non-transitory computer readable storage media according to claim 17, wherein the energy requirement is included in a charging assistance request message that further includes a device identifier, an energy level, and location coordinates and is generated by the respective IoT device.
